(19) United States
(12) Patent Application Publication
(10) Pub. No.: US 2013/0194897 A1
(43) Pub. Date: Aug. 1, 2013

(54) ELECTRONIC TIMEPIECE

(71) Applicant: SEIKO INSTRUMENTS INC., Chiba (JP)

(72) Inventors: Kazuo KATO, Chiba (JP); Akira TAKAKURA, Chiba (JP); Tomohiro IHASHI, Chiba (JP); Takanori HASEGAWA, Chiba (JP); Toshitaka FUKUSHIMA, Chiba (JP)

(73) Assignee: SEIKO INSTRUMENTS INC., Chiba (JP)

(21) Appl. No.: 13/738,066

(22) Filed: Jan. 10, 2013

(30) Foreign Application Priority Data
Jan. 30, 2012 (JP) 2012-017050

(51) Int. Cl. G04G 19/00

(52) U.S. Cl. CPC G04G 19/00
USPC 368/66

(57) ABSTRACT

There is provided an electronic timepiece of the invention that includes a solar panel which receives light to generate electric power, is operated with the electric power supplied from a secondary battery charged with an electromotive voltage of the solar panel, and stops a display operation of a display unit with transition to a power saving mode under predetermined conditions, the electronic timepiece including a control unit (mode control unit) which avoids transition from the normal mode to the power saving mode, when a voltage of the secondary battery is equal to or more than a predetermined voltage value.

### BACKGROUND OF THE INVENTION

1. Field of the Invention

The present invention relates to an electronic timepiece including a solar panel.

2. Background Art

There is a digital electronic watch with solar cells in the related art (for example, see JP-UM-A-56-97795). The digital electronic watch with solar cells disclosed in JP-UM-A-56-97795 blocks display output from a driver circuit, when output of the solar cells is equal to or less than a predetermined value.

There is an electronic timepiece in the related art (for example, see JP-A-61-77788). A digital electronic watch with solar cells disclosed in JP-A-61-77788 stops a time point display operation when incident light is not continuously obtained for equal to or more than given time.

In an electronic timepiece including a solar panel, when a secondary battery voltage is fully-charged, in order to prevent overcharging of the secondary battery, a method of reducing the output voltage of the solar panel by an overcharge protection circuit, for example, a method of short-circuiting the output side of the solar panel, has been used.

However, if the overcharge protection method of short-circuiting the output side of this solar panel is used for the electronic timepiece disclosed in JP-UM-A-56-97795 or JP-A-61-77788 as is, in a state where the output side of the solar panel is short-circuited, the output voltage is detected, and the timepiece enters a power saving mode as not having light incident to the solar panel, even in a case where there is illuminance of the solar panel by received light.

### SUMMARY OF THE INVENTION

It is an aspect of the present application to provide an electronic timepiece which is capable of, when the output voltage of a solar panel is reduced by detecting an overcharged state of a secondary battery, avoiding a determination error of there being no light incident to the solar panel due to reduction of the output voltage of the solar panel and erroneous transition of the electronic timepiece to a power saving mode due to this determination error.

According to another aspect of the application, there is provided an electronic timepiece that includes a solar panel which receives light to generate electric power, is operated with the electric power supplied from a secondary battery charged with an electromotive voltage of the solar panel, and includes a normal mode in which time point display is performed on a display unit, and a power saving mode in which a state where light incident to the solar panel is not obtained is detected to stop time point display of the display unit, the electronic timepiece including: a control unit which avoids transition from the normal mode to the power saving mode, when the voltage of the secondary battery is equal to or more than a predetermined first voltage value.

According to another aspect of the application, in the electronic timepiece, the electronic timepiece further includes an overcharge protection circuit which reduces an output voltage of the solar panel when the voltage of the secondary battery is equal to the predetermined first voltage value or equal to or more than a predetermined second voltage value which exceeds the first voltage value, and, in a state where the output voltage of the solar panel is reduced due to the operation of the overcharge protection circuit, the control unit avoids the transition from the normal mode to the power saving mode.

According to another aspect of the application, in the electronic timepiece, the electronic timepiece further includes: an illuminance detection circuit which outputs an illuminance signal which shows whether or not the light incident to the solar panel is obtained, by detecting the output voltage of the solar panel; a battery voltage detection circuit which detects a voltage of the secondary battery and outputs the voltage as a battery voltage signal; a non-illuminance time detection unit which measures a non-illuminance duration time in which the light incident to the solar panel is not obtained based on the illuminance signal; and the control unit which compares the non-illuminance duration time to predetermined transition time, and transitions to the power saving mode to stop the time point display of the display unit when the non-illuminance duration time surpasses the transition time, and, when the voltage of the secondary battery is equal to or more than the predetermined second voltage value and the overcharge protection circuit is operated, the control unit avoids transition from the normal mode to the power saving mode by stopping the measurement operation in the non-illuminance duration time of the non-illuminance time detection unit.

According to another aspect of the application, in the electronic timepiece, in a state of being transitioned to the power saving mode, when any of a state where the voltage of the secondary battery is equal to or more than the first voltage value, a state where the light incident to the solar panel is obtained, and a state where a manipulation unit for manipulating the electronic timepiece is manipulated are detected, the control unit transitions from the power saving mode to the normal mode.

According to another aspect of the application, in the electronic timepiece, the overcharge protection circuit reduces the output voltage of the solar panel by short-circuiting an output terminal of the solar panel.

According to the application, when the voltage of the secondary battery is equal to or more than the predetermined first voltage, the electronic timepiece avoids transition to the power saving mode. Accordingly, it is possible to provide an electronic timepiece which is capable of, when the overcharged state of the secondary battery is detected to reduce the output voltage of a solar panel, avoiding a determination error of there being no light incident to the solar panel due to a reduction of the output voltage of the solar panel and erroneous transition of the electronic timepiece to a power saving mode due to this determination error.

### BRIEF DESCRIPTION OF THE DRAWINGS

FIGS. 1A to 1D are diagrams showing a general configuration of an electronic timepiece.

FIG. 2 is a block diagram showing an internal configuration of an electronic timepiece.

FIG. 3 is a diagram showing a relationship between an illuminance detection operation and a transition operation to a power saving mode according to voltage of a secondary battery.

FIGS. 4A and 4B are flowcharts illustrating a transition operation between a normal mode and a power saving mode in an electronic timepiece.

### DETAILED DESCRIPTION OF THE INVENTION

Hereinafter, an embodiment of the present invention will be described with reference to the drawings.

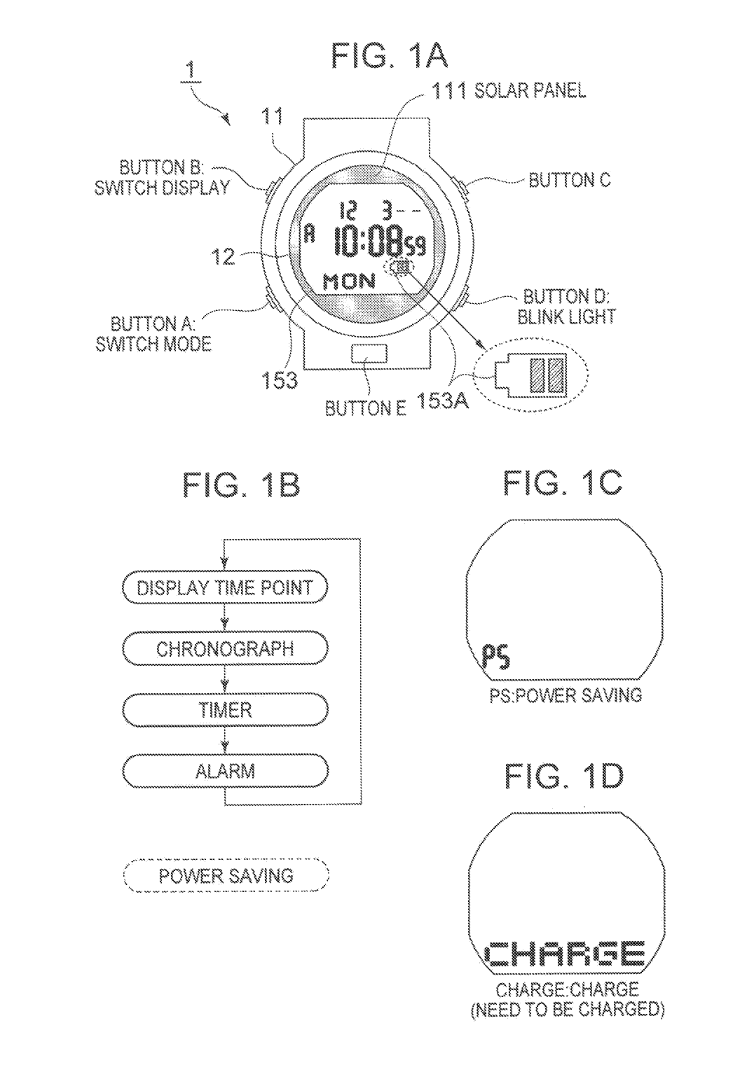

FIGS. 1A to 1D are diagrams showing a general configuration of an electronic timepiece according to the embodiment of the present invention.

As shown in FIG. 1, an electronic timepiece 1 of the embodiment includes a main body case 11, and an LCD (liquid crystal display) 153 and a solar panel 111 are provided under a transparent plate 12 such as a windshield glass in a rectangular shape with four corners in a front surface side of the main body case 11. The LCD 153 is provided in the center of the transparent plate 12. The solar panel 111 is disposed on a periphery portion of the transparent plate 12 so as to surround the LCD 153 in a plan view.

In addition, a manipulation button A, a manipulation button B, a manipulation button C, and a manipulation button D which can be manipulated by a user are provided on side surfaces of the main body case 11. Further, a manipulation button E is provided on the surface of the main body case 11.

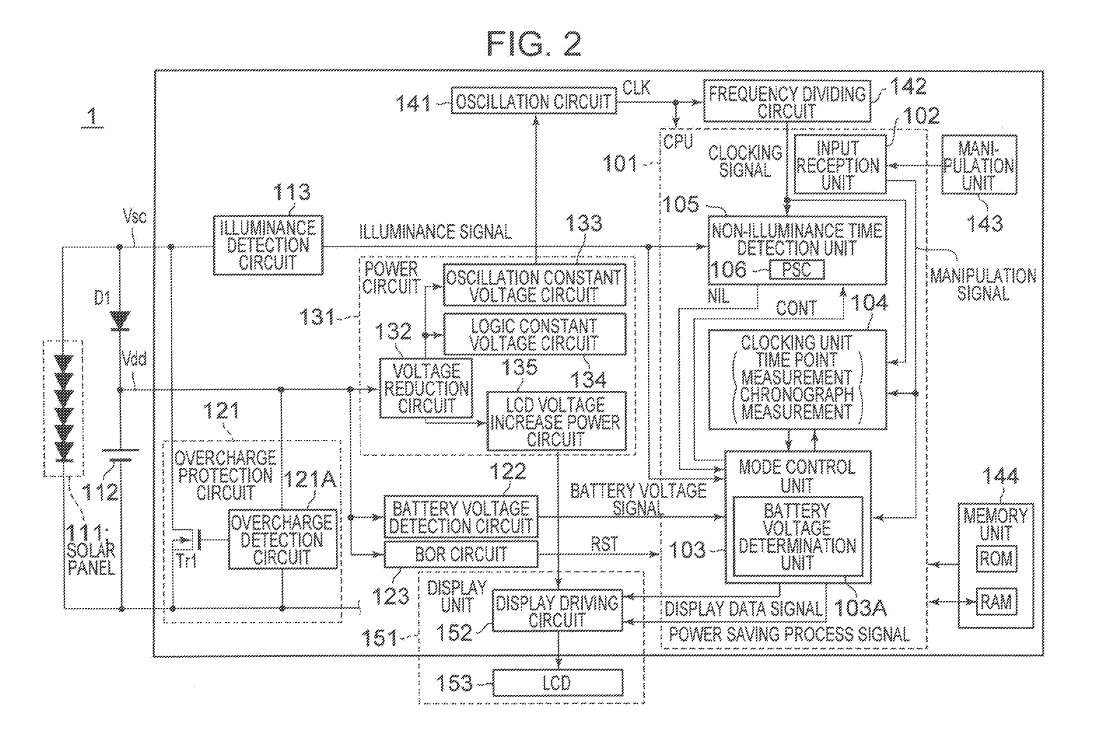

The manipulation button A outputs a mode change signal which is a signal for changing the operation mode of the electronic timepiece 1. Whenever the manipulation button A is pressed, the mode change signal is output to a mode control unit 103 (see FIG. 2) in a CPU 101 which will be described later. As shown in FIG. 1B, the mode control unit 103 responds to the mode change signal to transition the electronic timepiece to a time point display mode, a chronograph mode, a timer mode, and an alarm mode in this order, or the mode control unit 103 transitions the electronic timepiece 1 to a power saving mode under predetermined conditions which will be described later.

Herein, the time point display mode is a mode in which normal time point display is performed, and as shown in FIG. 1A, the date, current time, and day are displayed on the LCD 153, for example.

The chronograph mode is a mode used for time measurement and display of a record in a sporting event or the like, and is a mode in which a lap time or split time is measured to be displayed, for example.

The timer mode is a mode in which a timer time is set in advance in the timer, the time is measured by counting down the time set in this timer, and an alarm sound is sounded at a count of zero. In addition, the alarm mode is a mode in which the time point is set in advance, and an alarm sound is sounded when the measured time point becomes the set time point.

The power saving mode is a mode for turning off the display of the LCD 153 in order to prevent a wasteful amount of electricity consumption of the secondary battery, when a state where light is not incident to the solar panel 111 is continued for a given time or more. In this power saving mode, the electronic timepiece 1 displays only “PS” on the LCD 153 as shown in FIG. 1C. In addition, other than the operation mode described above, there are cases where the operation mode includes, for example, a world time display mode (mode in which the time point of major cities of the world is displayed), a re-call mode (function for calling the measured data), or the like.

The manipulation button B is a switching button for display, and is a button for performing switching of display of the lap time (LAP) and the split time (SPL), in the chronograph mode (time measurement mode), for example.

The manipulation button C is a start/stop button, and is a button for indicating the start and the end of the time measurement operation in the chronograph mode, for example.

The manipulation button D is a button with a blinking light (internal illumination), and when the manipulation button D is pressed, for example, an electroluminescence (EL) panel used as a light emits light.

The manipulation button E is a button for storing the lap time (LAP) and resetting a measurement value in the chronograph mode, for example.

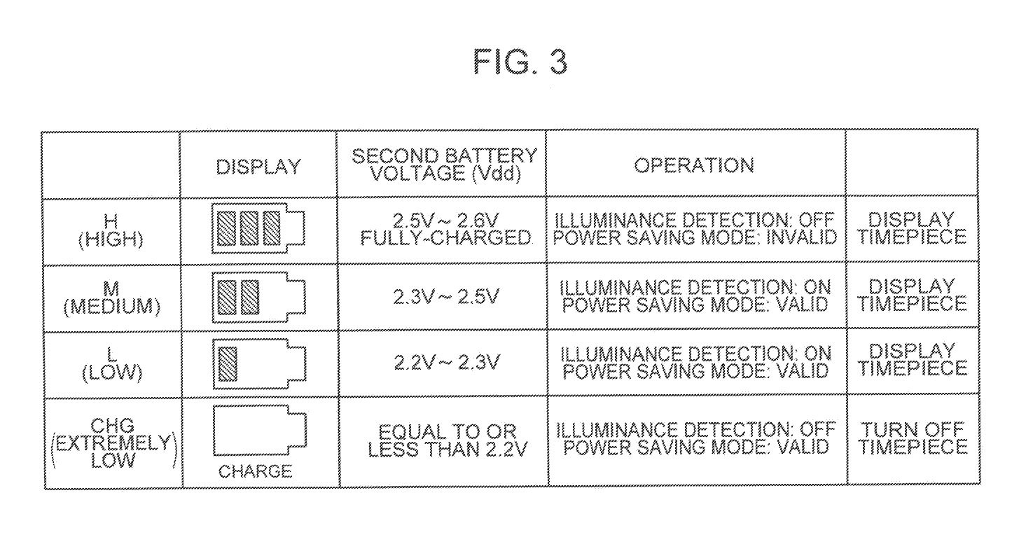

In addition, a remaining battery level display 153A is displayed on the LCD 153. This remaining battery level display 153A changes a display mode according to the remaining battery level (more properly, voltage of the secondary battery). For example, as shown in FIG. 3, the remaining battery level display 153A changes the display mode according to each case of a case where the remaining battery level is H (high), a case where the remaining battery level is M (medium), a case where the remaining battery level is L (low), and a case where the remaining battery level is CHG (extremely low). Then, in a case where the remaining battery level is CHG (extremely low) , as shown in FIG. 1D, “CHARGE” is displayed which shows the necessity for charging the secondary battery.

FIG. 2 is a block diagram showing an internal configuration of the electronic timepiece according to the embodiment of the present invention, and shows an example of the electronic timepiece including the solar panel 111. In FIG. 2, the electronic timepiece 1 includes a CPU (Central Processing Unit) 101, the solar panel 111, a secondary battery 112, an illuminance detection circuit 113, an overcharge protection circuit 121, a battery voltage detection circuit 122, a BOR circuit 123, a power circuit 131, an oscillation circuit 141, a frequency dividing circuit 142, a manipulation unit 143, a memory unit 144, and a display unit 151.

In addition, the CPU 101 includes an input reception unit 102, the mode control unit 103, a clocking unit 104, and a non-illuminance time detection unit 105. The CPU 101 includes an input and output port, and includes a timer and a counter therein.

Hereinafter, each unit configuring the electronic timepiece 1 will be described in detail.

The solar panel 111 is configured of a plurality of solar cells, and charges the secondary battery 112 with electromotive voltage Vsc (output voltage) of the solar panel 111. Each unit of the electronic timepiece 1 is operated with a power-supply voltage Vdd supplied from the solar panel 111 through the secondary battery 112, and various displays, such as time point display, are performed on the LCD 153.

The illuminance detection circuit 113 performs an illuminance detection operation for determining whether or not the electromotive voltage Vsc of the solar panel 111 is sufficient, regularly, for example, for every second or every minute. When the electromotive voltage Vsc of the solar panel 111 is not sufficient and is a voltage equal to or less than predetermined threshold voltage, the solar cells configuring the solar panel 111 is shielded, and the illuminance detection circuit 113 determines there to be no illuminance of the received light (no incident light). In addition, when the electromotive voltage Vsc of the solar panel 111 is sufficient voltage and is voltage equal to or more than predetermined threshold voltage, the solar cells configuring the solar panel 111 is not shielded, and the illuminance detection circuit 113 determines there to be illuminance of the received light (presence of incident light). The illuminance detection circuit 113 outputs an illuminance signal showing “presence of illuminance” or “absence of illuminance” to the non-illuminance time detection unit 105 and the mode control unit 103 of the CPU 101.

The overcharge protection circuit 121 includes a MOS transistor Tr1 which operates as a switch for preventing overcharging, and an overcharge detection circuit 121A which outputs a gate signal which turns on the MOS transistor Tr1. When the secondary battery 112 is overcharged and the voltage thereof is equal to or more than the predetermined voltage, for example, 2.6 V (second voltage value), the overcharge detection circuit 121A outputs the gate signal to turn on the MOS transistor Tr1. The transistor Tr1 is in an ON state due to the gate signal output from the overcharge detection circuit 121A and makes both ends of the solar panel 111 be in a short-circuited state. Accordingly, the electromotive voltage output from the solar panel 111 is not charged to the secondary battery 112, and the overcharge to the secondary battery 112 is prevented. In addition, when light is not emitted to the solar panel 111, a backflow prevention diode D1 prevents the current from flowing backward from the secondary battery 112 to the solar panel 111.

The battery voltage detection circuit 122 is a circuit for detecting output voltage Vdd of the secondary battery 112, converts a voltage value of the output voltage Vdd of the secondary battery 112 into a digital signal, and outputs the digital signal to the mode control unit 103 in the CPU 101 as a battery voltage signal.

The BOR circuit 123 is a brown-out reset circuit, and is a circuit which generates a reset signal RST to output to the CPU 101 when the secondary battery voltage Vdd is equal to or less than the predetermined voltage.

The power circuit 131 is a circuit which supplies power necessary for the operation of each unit based on the secondary battery voltage Vdd. The power circuit 131 includes a voltage reduction circuit 132, an oscillation constant voltage circuit 133, a logic constant voltage circuit 134, and an LCD voltage increase power circuit 135. The voltage reduction circuit 132 is a circuit for temporarily reducing the battery voltage Vdd to the predetermined voltage. The oscillation constant voltage circuit 133 is a circuit which generates the power necessary for driving the oscillation circuit 141 and converts the voltage output from the voltage reduction circuit 132 into constant voltage necessary for driving the oscillation circuit 141 to output.

The logic constant voltage circuit 134 is a circuit which generates the power necessary for driving the logic circuit (electronic circuit which performs a logical operation) including the CPU 101 in the electronic timepiece 1, and converts the voltage output from the voltage reduction circuit 132 into constant voltage necessary for driving the logic circuit to output.

The LCD voltage increase power circuit 135 is a circuit which generates the power necessary for driving the LCD 153, and converts the voltage output from the voltage reduction circuit 132 into constant voltage necessary for driving the LCD 153 to output.

The oscillation circuit 141 generates a basic clock signal CLK which is an operation clock signal of the CPU 101 and is a signal to be an operation reference of each unit. The frequency dividing circuit 142 divides the frequency of the basic clock signal CLK to generate a clocking signal which is a signal for measuring the time in a time point measurement operation and a time measurement operation (chronograph measurement operation). The clocking signal is output to the clocking unit 104 and the non-illuminance time detection unit 105.

The manipulation unit 143 is configured of a plurality of manipulation buttons (see FIG. 1A) which can be manipulated by a user. In the manipulation unit 143, by performing the button manipulation by a user, a signal according to the button manipulation is input to the input reception unit 102 in the CPU 101. By manipulating the manipulation buttons of the manipulation unit 143, the user can perform switching of the operation mode, switching of display contents, adjustment of the time point, and various other settings in the electronic timepiece 1.

The display unit 151 is configured of a display driving circuit 152 and the LCD 153.

The display driving circuit 152 receives a display data signal according to each operation mode (for example, the time point display mode or the chronograph mode) from the mode control unit 103 in the CPU 101 and outputs the signal to the LCD 153. For example, in a case of the time point display mode, the display driving circuit 152 receives a display data signal corresponding to time point measurement data from the mode control unit 103 and displays the signal on the LCD 153. In addition, for example, in a case of the chronograph mode, the display driving circuit 152 receives a display data signal corresponding to chronograph measurement data from the mode control unit 103 and display the signal on the LCD 153.

In addition, when the electronic timepiece 1 transitions to the power saving mode and a power saving process signal is output from the mode control unit 103, the display driving circuit 152 turns off the display of the LCD 153. When the display of the LCD 153 is turned off in the power saving mode, the display driving circuit 152 performs display showing the power saving state (for example, text display “PS” shown in FIG. 1C) on the LCD 153.

The LCD 153 configured of a liquid crystal panel performs display according to the display data output from the display driving circuit 152, for example, display of each mode, time point display, and display of measured time, turns off the time point display when performing power saving, and performs a display showing a power saving state.

The memory unit 144 is configured of a ROM (Read Only Memory) and a RAM (Random Access Memory) . A process relating to the process performed in the electronic timepiece 1 is stored in a program format in the ROM, and by reading out and executing the program by the CPU 101, each process of the electronic timepiece 1 is performed. In addition, the RAM is used as an operating memory when the CPU 101 executes a process. In addition, various kinds of measurement data measured in the electronic timepiece are stored and held in the memory unit 144. For example, the memory unit 144 stores data such as a lap time or split time measured by the time measurement operation in the chronograph mode. In addition, the memory unit 144 stores information of a predetermined transition time (in the embodiment, 30 minutes) therein. The transition time can be manually set by manipulating the manipulation buttons of the manipulation unit 143 by a user. For example, the transition time can be set in a range of 30 minutes to four hours, and can also be set to an arbitrary time equal to or more than four hours.

In addition, the input reception unit 102 in the CPU 101 receives a signal of the button manipulation input from the manipulation unit 143 as an external interruption request signal, holds that the button manipulation in the manipulation unit 143 is performed and contents thereof in a register (not shown), and outputs a manipulation signal according to the contents of the button manipulation to each unit in the CPU 101. For example, since the operation mode of the electronic timepiece 1 changes, the input reception unit 102 outputs the mode change signal from the manipulation unit 143 to the mode control unit 103 as the manipulation signal. In addition, the input reception unit 102 outputs the manipulation signal for performing adjustment of the time point or various other settings in the clocking unit 104 with respect to the clocking unit 104. The input reception unit 102 outputs a button manipulation signal indicating whether or not the button manipulation is performed in the manipulation unit 143, to the mode control unit 103.

The mode control unit 103 is a control unit which sets the operation mode of the electronic timepiece 1 and controls the operation of the clocking unit 104 and the non-illuminance time detection unit 105. For example, the mode control unit 103 outputs a control signal CONT to the non-illuminance time detection unit 105, and controls on/off (execution/stop) of the measurement operation of the non-illuminance time detection unit 105 due to the control signal CONT.

The mode control unit 103 responds to the manipulation signal (for example, manipulation signal corresponding to the mode change signal from the manipulation unit 143) output from the manipulation unit 143 to set the operation mode of the electronic timepiece 1. In addition, the mode control unit 103 outputs a display data signal for displaying the display data according to the set operation mode on the LCD 153 to the display driving circuit 152.

In addition, the mode control unit 103 receives a signal showing non-illuminance duration time NIL (time in which a state where light incident to the solar panel 111 is not obtained is continued) from the non-illuminance time detection unit 105 and compares the non-illuminance duration time NIL with a predetermined transition time. Then, when the non-illuminance duration time NIL surpasses a predetermined transition time (for example, 30 minutes), the mode control unit 103 transitions the electronic timepiece 1 to the power saving mode, and outputs a power saving process signal for turning off the display of the LCD 153 with respect to the display driving circuit 152.

The clocking unit 104 performs time point measurement by counting number of clocking signals input from the frequency dividing circuit 142, and generates time point measurement data which is a signal showing the time point. In addition, in the chronograph mode, the clocking unit 104 performs the time measurement operation by counting number of the clocking signals input from the frequency dividing circuit 142, and generates time measurement data. The time point measurement data and the time measurement data generated in the clocking unit 104 are output to the mode control unit 103. The time point measurement data and the time measurement data are output to the display driving circuit 152 through the mode control unit 103 as display data signals. For example, in a case of the time point display mode, the mode control unit 103 outputs the time point measurement data to the display driving circuit 152 as the display data signal.

The non-illuminance time detection unit 105 receives the illuminance signal from the illuminance detection circuit 113. The non-illuminance time detection unit 105 measures the non-illuminance duration time NIL in which a state where the light incident to the solar panel is not obtained is continued. The measurement of the non-illuminance duration time NIL is performed by counting number of period signals (for example, period signals for every minute) generated based on the clocking signal input from the frequency dividing circuit 142 by a power saving counter (PSC) 106. Then, the non-illuminance time detection unit 105 outputs a signal showing the measured non-illuminance duration time NIL to the mode control unit 103.

In the electronic timepiece 1 configured as described above, by manipulating the manipulation unit 143, for example, manipulating the manipulation button A (see FIGS. 1A to 1D) by a user, the manipulation signal (in this case, the manipulation signal corresponding to the mode change signal from the manipulation unit 143) for changing the operation mode of the electronic timepiece 1 and the display mode of the LCD 153 is output to the mode control unit 103. The mode control unit 103 responds to the manipulation signal corresponding to the mode change signal to change the operation mode of the electronic timepiece 1. As shown in FIG. 1B described above, operation mode of the electronic timepiece 1, for example, includes the time point display mode, the chronograph mode, the timer mode, the alarm mode, and the power saving mode which is transitioned under the predetermined conditions.

In the time point display mode, the clocking unit 104 counts number of the clocking signals output from the frequency dividing circuit 142 to generate time point measurement data showing the time point, and outputs this time point measurement data to the mode control unit 103. In addition, in the chronograph mode, the clocking unit 104 counts number of the clocking signals output from the frequency dividing circuit 142 to generate time measurement data, and outputs this time measurement data to the mode control unit 103.

When the electronic timepiece 1 is set to be in the time point display mode, the mode control unit 103 outputs the display data signal including the time point measurement data to the display driving circuit 152. The display driving circuit 152 converts the time point measurement data into a format suitable to be displayed and outputs it to the LCD 153, and the LCD 153 digitally displays the time point corresponding to the time point measurement data.

In addition, when the electronic timepiece 1 is set to be in the chronograph mode, the mode control unit 103 outputs the display data signal including the time measurement data to the display driving circuit 152. The display driving circuit 152 converts the time measurement data into a format suitable to be displayed and outputs it to the LCD 153, and the LCD 153 digitally displays the time corresponding to the time measurement data.

The non-illuminance time detection unit 105 receives the illuminance signal from the illuminance detection circuit 113, and measures the non-illuminance duration time NIL in which a state where the light incident to the solar panel is not obtained is continued by the power saving counter (PSC) 106. The non-illuminance time detection unit 105 generates predetermined period signals (for example, signals for every minute) based on the clocking signals output from the frequency dividing circuit 142, and measures the non-illuminance duration time NIL by counting numbers of the period signals with the power saving counter 106. The non-illuminance time detection unit 105 outputs the signal showing the measured non-illuminance duration time NIL to the mode control unit 103.

The non-illuminance time detection unit 105 controls the operation thereof with the control signal CONT output from the mode control unit 103, and stops the measurement operation of the non-illuminance duration time NIL when the control signal CONT indicates to turn off the operation (to stop the operation). In addition, when the control signal CONT indicates to turn on the operation (to execute the operation), the non-illuminance time detection unit 105 executes the measurement operation of the non-illuminance duration time NIL.

The mode control unit 103 includes a battery voltage determination unit 103A, and a battery voltage value shown by the battery voltage signal input from the battery voltage detection circuit 122 is compared with the voltage value (for example, 2.5 V) showing the fully-charged state of the secondary battery 112, with the battery voltage determination unit 103A.

Then, when it is determined that the voltage of the secondary battery 112 is equal to or more than 2.5 V and is in the fully-charged state, the mode control unit 103 outputs the control signal CONT indicating to turn off the operation to the non-illuminance time detection unit 105, and turns off (stop) the measurement operation of the non-illuminance duration time NIL of the non-illuminance time detection unit 105. In addition, when it is determined that the voltage of the secondary battery 112 is less than 2.5 V and is not in the fully-charged state, the mode control unit 103 outputs the control signal CONT indicating to turn on the operation to the non-illuminance time detection unit 105, and turns on (executes) the measurement operation of the non-illuminance duration time NIL of the non-illuminance time detection unit 105.

In addition, the mode control unit 103 receives the signal showing the non-illuminance duration time NIL (time in which a state where light incident to the solar panel 111 is not obtained is continued) from the non-illuminance time detection unit 105.

Then, when the non-illuminance duration time NIL surpasses predetermined transition time (for example, 30 minutes), the mode control unit 103 transitions the electronic timepiece 1 to the power saving mode, and outputs the power saving process signal for turning off the display of the LCD 153 with respect to the display driving circuit 152.

FIG. 3 is a diagram showing a relationship between the illuminance detection operation and the transition operation to the power saving mode according to the second battery voltage Vdd. In FIG. 3, the charged modes of the secondary battery 112 are divided into four states of H (high), M (medium), L (low), and CHG (extremely low), and on/off of the illuminance detection of the non-illuminance time detection unit 105 and valid/invalid of the transition to the power saving mode according to each charged state is shown in table.

In FIG. 3, the state of H (high) is the fully-charged state where the secondary battery voltage Vdd is 2.5 V to 2.6 V, and the mode control unit 103 turns off (stops) the illuminance detection of the non-illuminance time detection unit 105, and invalidates the transition to the power saving mode. That is, in the state of H (high), the measurement detection operation of the non-illuminance duration time NIL of the illuminance time detection unit 105 is stopped, and the transition to the power saving mode is inhibited.

In addition, 2.6V (second voltage value) described above is overcharge detection voltage with which the overcharge protection circuit 121 starts the protection operation, and 2.5 V (first voltage value) is full charge detection voltage with which the illuminance detection operation of the non-illuminance time detection unit 105 is turned off (stopped). In this example, the overcharge detection voltage (2.6 V) is set to be higher than the full charge detection voltage (2.5 V), however, in a desired case, the overcharge detection voltage (second voltage value) and the full charge detection voltage (first voltage value) can be set to be the same voltage value.

In the H state, by stopping the measurement operation of the non-illuminance duration time NIL of the non-illuminance time detection unit 105, the mode control unit 103 invalidates the transition to the power saving mode, as a result. In H state, since the illuminance detection operation of the non-illuminance time detection unit 105 is turned off, even in a case where the state where light is not incident to the solar panel 111 is continued (for example, continued for 30 minutes or more), the electronic timepiece 1 can continue the display of the timepiece of the display unit 151 without the transition to the power saving mode.

In addition, the state of M (medium) is a state where the Secondary battery voltage Vdd is 2.3 V to 2.5 V, the mode control unit 103 turns on the illuminance detection operation of the non-illuminance time detection unit 105, and validates the function of transitioning to the power saving mode. In the M state, the electronic timepiece 1 performs the display of timepiece in the normal mode, and, when the state where the light is not incident to the solar panel 111 is continued (for example, continued for 30 minutes or more), the electronic timepiece is transitioned to the power saving mode to stop the display of timepiece.

In addition, the state of L (low) is a state where the secondary battery voltage Vdd is 2.2 V to 2.3V, the mode control unit 103 turns on the illuminance detection operation of the non-illuminance time detection unit 105, and validates the function of transitioning to the power saving mode. In the L state, the electronic timepiece 1 performs the display of timepiece in the normal mode, and, when a state where the light is not incident to the solar panel 111 is continued (for example, continued for 30 minutes or more) , the electronic timepiece is transitioned to the power saving mode to stop the display of timepiece.

In addition, the state of CHG (extremely low) is a state where the secondary battery voltage Vdd is equal to or less than 2.2 V, the mode control unit 103 turns off the illuminance detection operation of the non-illuminance time detection unit 105 and turns off the display of timepiece. In this CHG state, the mode control unit 103 turns off the display of timepiece of the display unit 151, and displays “CHARGE” on the display unit 151 to promote to charge.

As described above, in the electronic timepiece 1 of the embodiment, when the battery voltage of the secondary battery 112 is in the fully-charged state to be equal to or more than 2.5 V, the mode control unit 103 stops the measurement operation of the non-illuminance duration time NIL of the non-illuminance time detection unit 105. Accordingly, in a state where the overcharge protection circuit 121 detects the overcharged state of the secondary battery 112 to reduce the output voltage Vsc of the solar panel 111, it is possible to avoid a determination error that the state where the light is not incident to the solar panel 111 is continued for predetermined time by the non-illuminance time detection unit 105 and erroneous transition of the electronic timepiece 1 to the power saving mode due to the determination error.

Next, the transition operation between the normal mode and the power saving mode of the electronic timepiece 1 of the embodiment will be described.

As described above, when the state where the light is not incident to the solar panel 111 is continued for a given time, the electronic timepiece 1 is transitioned to the power saving mode to prevent the unnecessary amount of electricity consumption of the secondary battery 112. In this case, when the secondary battery 112 is in the fully-charged state, the electronic timepiece 1 stops the measurement operation of the non-illuminance duration time NIL of the non-illuminance time detection unit 105 to avoid the transition thereof to the power saving mode.

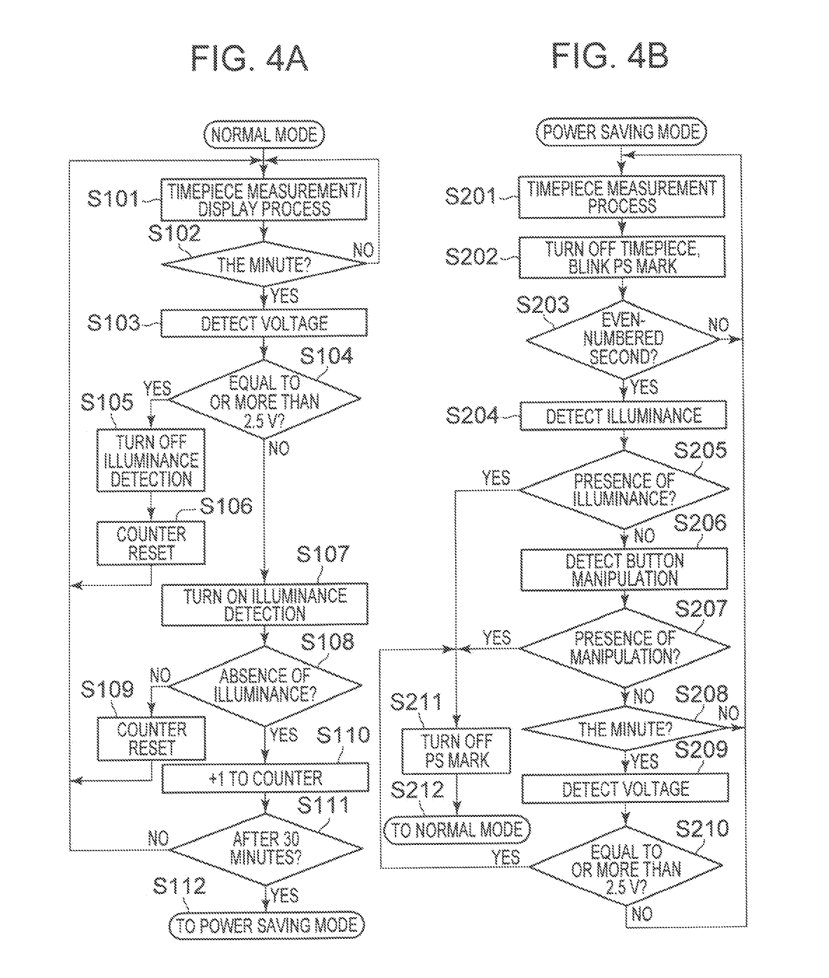

FIGS. 4A and 4B are flowcharts for illustrating the transition operation between the normal mode and the power saving mode of the electronic timepiece 1. FIG. 4A shows a flow of a process in a case of the transition from the normal mode to the power saving mode, and FIG. 4B shows a flow of a process in a case of the transition from the power saving mode to the normal mode.

First, the flow of the process in a case of the transition from the normal mode to the power saving mode will be described with reference to FIG. 4A. The process shown in FIG. 4A is a process performed by being repeated every minute in the CPU 101 (mainly mode control unit 103), and in the normal mode, the power saving counter 106 for measuring light shielding time of the solar panel 111 is initialized (reset) to zero.

With reference to FIG. 4A, in the normal mode, the mode control unit 103 performs a time point measurement process of the clocking unit 104 and a time point display process of the display unit 151 (step S101). Then, the mode control unit 103 determines whether or not the current time point is the minute (in minute units, 00.00 second) based on the time point measurement data measured in the clocking unit 104 (step S102). When it is determined that the time point is not the minute in the process of step S102 (step S102; No), the mode control unit 103 returns to the process of step S101 and continues the time point measurement process of the clocking unit 104 and the time point display process of the display unit 151.

When it is determined that the time point is the minute in the process of step S102 (step S102; Yes), the mode control unit 103 determines the voltage value of the battery voltage Vdd of the secondary battery 112 in the battery voltage determination unit 103A in the mode control unit 103 (step S103), and determines whether or not the battery voltage Vdd is equal or more than 2.5 V (first voltage value) (step S104).

Then, when it is determined that the secondary battery voltage Vdd is equal to or more than 2.5 V in the process of step S104 (step S104; Yes), the mode control unit 103 turns off the illuminance detection of the non-illuminance time detection unit 105. That is, the mode control unit 103 outputs the control signal CONT which turns off the measurement operation of the non-illuminance duration time NIL, and stops the measurement operation of the non-illuminance duration time NIL of the non-illuminance time detection unit 105 (step S105).

When the measurement operation of the non-illuminance duration time NIL is stopped, the non-illuminance time detection unit 105 resets the counted value of the power saving counter 106 (step S106). Then, the process returns to the process of step S101 after the end of the process of step S104, the mode control unit 103 continues the time point measurement process of the clocking unit 104 and the time point display process of the display unit 151.

Meanwhile, in the process of step S104, when it is determined that the secondary battery voltage Vdd is less than 2.5 V (step S104; No), the mode control unit 103 turns on the illuminance detection of the non-illuminance time detection unit 105. That is, the mode control unit 103 outputs the control signal CONT which turns on the measurement operation of the non-illuminance duration time NIL, and performs the measurement operation of the non-illuminance duration time NIL of the non-illuminance time detection unit 105 (step S107). Then, the non-illuminance time detection unit 105 determines whether or not the illuminance is obtained in the solar panel 111, that is, whether or not the light incident to the solar panel 111 is obtained, based on the illuminance signal output from the illuminance detection circuit 113 (step S108).

Then, when it is determined that the illuminance is obtained in the process of step S108 (step S108; No) , the non-illuminance time detection unit 105 initializes (resets) the counted value of the power saving counter 106 (step S109). After that, the process proceeds to the process of step S101, and the mode control unit 103 continues the time point measurement process of the clocking unit 104 and the time point display process of the display unit 151.

Meanwhile, when it is determined that the illuminance is not obtained in the process of step S108 (step S108; Yes), the non-illuminance time detection unit 105 transitions to the process of step 5110 and increments (adds +1) the counted value of the power saving counter 106 (step s110). The non-illuminance time detection unit 105 outputs the counted value of the power saving counter 106 to the mode control unit 103 as a signal showing the non-illuminance duration time NIL.

Next, the mode control unit 103 which receives the signal showing the non-illuminance duration time NIL from the non-illuminance time detection unit 105 compares the non-illuminance duration time NIL with the predetermined transition time (for example, 30 minutes) (step S111). Then, when it is determined that the non-illuminance duration time NIL exceeds the predetermined transition time (for example, 30 minutes) in the process of step S111 (step S111; Yes), the mode control unit 103 transitions the electronic timepiece 1 to the power saving mode (step S112).

In addition, when it is determined that the non-illuminance duration time NIL does not exceed the predetermined transition time (for example, 30 minutes) in the process of step S111 (step S111; No), the process returns to the process of step S101, and the mode control unit 103 continues the time point measurement process of the clocking unit 104 and the time point display process of the display unit 151. The comparison process of the non-illuminance duration time NIL and the transition time (for example, 30 minutes) of step S111 may be performed in the non-illuminance time detection unit 105, not in the mode control unit 103.

As described above, when the secondary battery 112 is in the fully-charged state, for example, when the battery voltage Vdd is equal to or more than 2.5 V, the mode control unit 103 stops the measurement operation of the non-illuminance duration time NIL of the non-illuminance time detection unit 105 to avoid the transition of the electronic timepiece 1 to the power saving mode. In addition, when it is determined that the battery voltage of the secondary battery 112 is equal to or less than 2.5 V and the light incident to the solar panel 111 is not continuously obtained for 30 minutes or more, the mode control unit 103 transitions the electronic timepiece 1 to the power saving mode.

Next, a flow of a process in a case of transition from the power saving mode to the normal mode will be described with reference to FIG. 4B. The process shown in FIG. 4B is a process performed by being repeated for every two seconds in the CPU 101 (mainly mode control unit 103).

In the power saving mode, the mode control unit 103 performs the time point measurement process of the clocking unit 104 (step S201). Then, the mode control unit 103 turns off the display of timepiece of the LCD 153, that is, stops the display of timepiece, and blinks a PS (power saving) mark (step S202).

Then, the mode control unit 103 determines whether or not the current time point is at an even-numbered second, based on the time point measurement data measured in the clocking unit 104 (step S203). When it is determined that the time point is not at an even-numbered second in the process of step S203 (step S203; No) , the process returns to the process of step S201, and the mode control unit 103 continues the time point measurement process of the clocking unit 104.

In addition, when it is determined that the current time point is at an even-numbered second in the process of step S203 (step S203; Yes), the non-illuminance time detection unit 105 determines whether or not the illuminance is obtained in the solar panel 111, that is, whether or not the light incident to the solar panel 111 is obtained (step S205), based on the illuminance signal output from the illuminance detection circuit 113 (step S204).

When it is determined that the illuminance is obtained in the process of step S205 (step S205; Yes) , the process proceeds to the process of step S211, and the mode control unit 103 turns off the PS mark displayed on the display unit 151 and transitions the electronic timepiece 1 to the normal mode (step S212).

Meanwhile, when it is determined that the illuminance is not obtained in step S205 (step S205; No), the process proceeds to step S206, and the mode control unit 103 determines whether or not the button manipulation (more properly, button manipulation which results in release of the power saving mode) of the manipulation unit 143 is performed, based on the manipulation signal output from the input reception unit 102 (step S207). Then, when it is determined that the button manipulation is performed (step S207; Yes) , the process proceeds to the process of step S211, and the mode control unit 103 turns off the PS mark displayed on the display unit 151 and transitions the electronic timepiece 1 to the normal mode (step S212).

Meanwhile, when it is determined that the button manipulation is not performed in the process of step S207 (step S207; No), the process proceeds to the process of step S208, and the mode control unit 103 determines whether or not the current time point is the minute measured in the clocking unit 104 (step S208). Then, when it is determined that the current time point is not the minute in the process of step S208 (step S208; No) , the process proceeds to step S201, and the mode control unit 103 continues the measurement process of the clocking unit 104.

Meanwhile, when it is determined that the current time point is the minute in the process of step S208 (step S208; Yes), the mode control unit 103 detects the battery voltage of the secondary battery 112 based on the battery voltage signal output from the battery voltage detection circuit 122 (step S209). In addition, the detection operation of the battery voltage Vdd of the battery voltage detection circuit 122 is performed for every minute, and the battery voltage signal output from the battery voltage detection circuit 122 is updated for every minute.

Then, the mode control unit 103 determines whether or not the secondary battery voltage Vdd is equal to or more than 2.5 V by the battery voltage determination unit 103A (step S210). When it is determined that the secondary battery voltage Vdd is equal to or more than 2.5 V in the process of step S210 (step S210; Yes), the process proceeds to the process of step 5211, the mode control unit 103 turns off the PS mark displayed on the display unit 151 (step S211) and transitions the electronic timepiece 1 to the normal mode (step S212).

In addition, when it is determined that the secondary battery voltage Vdd is not equal to or more than 2.5 V by the battery voltage determination unit 103A in the process of step S210 (step S210; No), the process proceeds to step S201, and the mode control unit 103 continues the measurement process of the clocking unit 104.

As described above, in a state where the electronic timepiece 1 is transitioned to the power saving mode, when any states of the state where the light incident to the solar panel 111 is obtained, a state where the button manipulation in the manipulation unit 143 is performed, and the state where the battery voltage Vdd is equal to or more than 2.5 V (first voltage value) are detected, the mode control unit 103 transitions the electronic timepiece 1 from the power saving mode to the normal mode.

Accordingly, even when the electronic timepiece 1 is in a state of the power saving mode, the mode control unit 103 can rapidly return the electronic timepiece 1 to the normal mode, if necessary.

Hereinafter, the embodiment of the present invention has been described, however, herein a corresponding relationship between the present invention and the embodiment described above will be described additionally. In the embodiment, the electronic timepiece of the present invention corresponds to the electronic timepiece 1, the manipulation unit of the present invention corresponds to the manipulation unit 143, and the display unit of the present invention corresponds to the display unit 151. In addition, the non-illuminance time detection unit of the present invention corresponds to the non-illuminance time detection unit 105 in the CPU 101, and the control unit of the present invention corresponds to the mode control unit 103 in the CPU 101. Further, the first voltage value of the present invention corresponds to the voltage value (for example, 2.5 V) which determines the fully-charged state of the secondary battery 112, and the second voltage value of the present invention corresponds to the voltage value (for example, 2.6 V) which determines the overcharged state of the secondary battery 112.

In the embodiment, there is the electronic timepiece 1 that includes the solar panel 111 which receives light to generate electric power, is operated with the electric power supplied from the secondary battery 112 charged with the output voltage Vsc of the solar panel 111, and includes the normal mode in which the time point display is performed on the display unit 151, and the power saving mode in which the state where the light incident to the solar panel 111 is not obtained is detected to stop the time point display of the display unit 151, the electronic timepiece 1 including, the mode control unit 103 which avoids the transition from the normal mode to the power saving mode, when the voltage of the secondary battery 112 is equal to or more than the first voltage value (for example, equal to or more than 2.5 V).

When the voltage of the secondary battery 112 is equal to or more than the predetermined first voltage value (for example, equal to or more than 2.5 V) showing the fully-charged state, the electronic timepiece 1 with the configuration described above avoids the transition to the power saving mode.

Accordingly, when the overcharged state of the secondary battery 112 is detected to reduce the output voltage of the solar panel 111, it is possible to avoid the determination error that the light incident to the solar panel 111 is not obtained due to the reduction of the output voltage of the solar panel 111 and the transition of the electronic timepiece 1 to the power saving mode with an error due to the determination error.

In addition, in the embodiment, there is the electronic timepiece including the overcharge protection circuit 121 which reduces the output voltage Vsc of the solar panel 111 when the voltage of the secondary battery 112 is equal to the predetermined first voltage value (for example, 2.5 V) or is equal to or more than the predetermined second voltage value (for example, 2.6 V) which exceeds the first voltage value, in which, in a state where the output voltage of the solar panel 111 is reduced due to the operation of the overcharge protection circuit 121, the mode control unit 103 avoids the transition from the normal mode to the power saving mode.

When the secondary battery 112 is overcharged and the overcharge protection circuit 121 is operated, the electronic timepiece 1 with the configuration described above avoids the transition to the power saving mode.

Accordingly, when the overcharge protection circuit 121 detects the overcharged state of the secondary battery 112 to reduce the output voltage Vsc of the solar panel 111, it is possible to avoid the determination error that the light incident to the solar panel 111 is not obtained due to the reduction of the output voltage of the solar panel 111 and the transition of the electronic timepiece 1 to the power saving mode with an error due to the determination error.

In addition, in the embodiment, there is the electronic timepiece 1 including: the illuminance detection circuit 113 which outputs the illuminance signal which shows whether or not the light incident to the solar panel is obtained by detecting the output voltage Vsc of the solar panel 111; the battery voltage detection circuit 122 which detects voltage of the secondary battery 112 and outputs the voltage as the battery voltage signal; the non-illuminance time detection unit 105 which measures the non-illuminance duration time NIL in which the light incident to the solar panel 111 is not obtained based on the illuminance signal; and the mode control unit 103 which compares the non-illuminance duration time NIL to predetermined transition time (for example, 30 minutes), and transitions to the power saving mode to stop the time point display of the display unit 151 when the non-illuminance duration time NIL surpasses the transition time, in which, when the voltage of the secondary battery 112 is equal to or more than the predetermined second voltage value and the overcharge protection circuit 121 is operated, the mode control unit 103 avoids transition from the normal mode to the power saving mode by stopping the measurement operation in the non-illuminance duration time NIL of the non-illuminance time detection unit 105.

If the electronic timepiece 1 with the configuration described above is provided, when the voltage Vdd of the secondary battery is equal to or more than the predetermined second voltage value (for example, 2.6 V) and the overcharge protection circuit 121 is operated, the mode control unit 103 avoids the transition from the normal mode to the power saving mode by stopping the operation of the non-illuminance time detection unit 105.

Accordingly, when the overcharge protection circuit 121 detects the overcharged state of the secondary battery 112 to reduce the output voltage Vsc of the solar panel 111, it is possible to avoid the determination error that the light incident to the solar panel 111 is not obtained due to the reduction of the output voltage of the solar panel 111 and the transition of the electronic timepiece 1 to the power saving mode with an error due to the determination error.

Hereinabove, the embodiment of the present invention has been described, however the electronic timepiece of the present invention is not limited to the examples shown in the drawings described above, and it is needless to say that various modifications can be performed within a range not departing from the scope of the present invention.

What is claimed is:

1. An electronic timepiece that includes a solar panel which receives light to generate electric power, is operated with the electric power supplied from a secondary battery charged with an electromotive voltage of the solar panel, and includes a normal mode in which time point display is performed on a display unit, and a power saving mode in which a state where light incident to the solar panel is not obtained is detected to stop time point display of the display unit, the electronic timepiece comprising:
a control unit which avoids transition from the normal mode to the power saving mode, when a voltage of the secondary battery is equal to or more than a predetermined first voltage value.

2. The electronic timepiece according to claim 1, further comprising:
an overcharge protection circuit which reduces an output voltage of the solar panel when the voltage of the secondary battery is equal to the predetermined first voltage value or equal to or more than a predetermined second voltage value which exceeds the first voltage value,
wherein, in a state where the output voltage of the solar panel is reduced due to the operation of the overcharge protection circuit, the control unit avoids the transition from the normal mode to the power saving mode.

3. The electronic timepiece according to claim 1, further comprising:
an illuminance detection circuit which outputs an illuminance signal which shows whether or not the light incident to the solar panel is obtained, by detecting the output voltage of the solar panel;
a battery voltage detection circuit which detects a voltage of the secondary battery and outputs the voltage as a battery voltage signal;
a non-illuminance time detection unit which measures a non-illuminance duration time in which the light incident to the solar panel is not obtained based on the illuminance signal; and
the control unit which compares the non-illuminance duration time to predetermined transition time, and transitions to the power saving mode to stop the time point display of the display unit when the non-illuminance duration time surpasses the transition time,
wherein, when the voltage of the secondary battery is equal to or more than the predetermined second voltage value and the overcharge protection circuit is operated, the control unit avoids transition from the normal mode to the power saving mode by stopping the measurement operation in the non-illuminance duration time of the non-illuminance time detection unit.

4. The electronic timepiece according to claim 2, further comprising:
an illuminance detection circuit which outputs an illuminance signal which shows whether or not the light incident to the solar panel is obtained, by detecting the output voltage of the solar panel;
a battery voltage detection circuit which detects a voltage of the secondary battery and outputs the voltage as a battery voltage signal;
a non-illuminance time detection unit which measures a non-illuminance duration time in which the light incident to the solar panel is not obtained based on the illuminance signal; and
the control unit which compares the non-illuminance duration time to predetermined transition time, and transitions to the power saving mode to stop the time point display of the display unit when the non-illuminance duration time surpasses the transition time,
wherein, when the voltage of the secondary battery is equal to or more than the predetermined second voltage value and the overcharge protection circuit is operated, the control unit avoids transition from the normal mode to the power saving mode by stopping the measurement operation in the non-illuminance duration time of the non-illuminance time detection unit.

5. The electronic timepiece according to claim 1,
wherein, in a state of being transitioned to the power saving mode, when any of a state where the voltage of the secondary battery is equal to or more than the first voltage value, a state where the light incident to the solar panel is obtained, and a state where a manipulation unit for manipulating the electronic timepiece is manipulated, are detected, the control unit transitions from the power saving mode to the normal mode.

6. The electronic timepiece according to claim 2,
wherein, in a state of being transitioned to the power saving mode, when any of a state where the voltage of the secondary battery is equal to or more than the first voltage value, a state where the light incident to the solar panel is obtained, and a state where a manipulation unit for manipulating the electronic timepiece is manipulated, are detected, the control unit transitions from the power saving mode to the normal mode.

7. The electronic timepiece according to claim 3,
wherein, in a state of being transitioned to the power saving mode, when any of a state where the voltage of the secondary battery is equal to or more than the first voltage value, a state where the light incident to the solar panel is obtained, and a state where a manipulation unit for manipulating the electronic timepiece is manipulated, are detected, the control unit transitions from the power saving mode to the normal mode.

8. The electronic timepiece according to claim 4,
wherein, in a state of being transitioned to the power saving mode, when any of a state where the voltage of the secondary battery is equal to or more than the first voltage value, a state where the light incident to the solar panel is obtained, and a state where a manipulation unit for manipulating the electronic timepiece is manipulated, are detected, the control unit transitions from the power saving mode to the normal mode.

9. The electronic timepiece according to claim 2,
wherein the overcharge protection circuit reduces the output voltage of the solar panel by short-circuiting an output terminal of the solar panel.

10. The electronic timepiece according to claim 3,
wherein the overcharge protection circuit reduces the output voltage of the solar panel by short-circuiting an output terminal of the solar panel.

11. The electronic timepiece according to claim 4,
wherein the overcharge protection circuit reduces the output voltage of the solar panel by short-circuiting an output terminal of the solar panel.

12. The electronic timepiece according to claim 5,
wherein the overcharge protection circuit reduces the output voltage of the solar panel by short-circuiting an output terminal of the solar panel.

13. The electronic timepiece according to claim 6,
wherein the overcharge protection circuit reduces the output voltage of the solar panel by short-circuiting an output terminal of the solar panel.

14. The electronic timepiece according to claim 7,
wherein the overcharge protection circuit reduces the output voltage of the solar panel by short-circuiting an output terminal of the solar panel.

15. The electronic timepiece according to claim 8,
wherein the overcharge protection circuit reduces the output voltage of the solar panel by short-circuiting an output terminal of the solar panel.
